(19) United States
(12) Patent Application Publication
(10) Pub. No.: US 2017/0285239 A1
(43) Pub. Date: Oct. 5, 2017

(54) SELF-ILLUMINATING LIGHT GUIDE PLATE, BACKLIGHT MODULE, AND DISPLAY DEVICE

(71) Applicants: Le Holdings (Beijing) Co., Ltd., Beijing (CN); LE SHI ZHI XIN ELECTRONIC TECHNOLOGY (TIAN JIN) LIMITED, Tianjin (CN)

(72) Inventors: Kunpeng Zhu, Tianjin (CN); Zhishuai Jia, Tianjin (CN); Xianlei Meng, Tianjin (CN); Jinnan Zhang, Tianjin (CN); Fangdai Ye, Tianjin (CN); Yingduo Bi, Tianjin (CN)

(73) Assignees: Le Holdings (Beijing) Co., Ltd., Beijing (CN); LE SHI ZHI XIN ELECTRONIC TECHNOLOGY (TIAN JIN) LIMITED, Tianjin (CN)

(21) Appl. No.: 15/240,650

(22) Filed: Aug. 18, 2016

Related U.S. Application Data
(63) Continuation of application No. PCT/CN2016/088975, filed on Jul. 6, 2016.

(30) Foreign Application Priority Data
Mar. 30, 2016 (CN) 201620261055.2

(51) Int. Cl. F21V 8/00

(52) U.S. Cl. CPC G02B 6/0016; G02B 6/0065

(57) ABSTRACT

Disclosed are a self-illuminating light guide plate, a backlight module, and a display device. The self-illuminating light guide plate includes a substrate including at least one light incidence face provided with a white light emitting layer. The light incidence face of the substrate is provided with a white light emitting layer, so the self-illuminating light guide plate for a backlight module can act as light sources, as compared with the prior art where the LED BAR acts as light sources, the disclosure can avoid pictures of the backlight module from becoming poor due to errors in assembling the LED BAR, and further improve quality of pictures on a display device; and light emitted by the white light emitting layer can vary with shape of the substrate, so a display device with curved display surface to which the self-illuminating light guide plate is applied has a promising prospective.

### CROSS REFERENCE TO RELATED APPLICATIONS

This application is a continuation of International Application No. PCT/CN2016/088975, filed Jul. 6, 2016, which claims priority to Chinese Patent Application No. 201620261055.2, filed with the Chinese Patent Office on Mar. 30, 2016, both of which are hereby incorporated by reference in their entireties.

### TECHNICAL FIELD

The present disclosure relates to the field of display technologies, and particularly to a self-illuminating light guide plate, backlight module, and display device.

### BACKGROUND

At present, Light Emitting Diodes (LEDs) are commonly used as light sources in a backlight module of a liquid crystal display device. The backlight module can be categorized into a direct-type backlight module, and an edge-lighting type backlight module, dependent upon the positions where the light sources are distributed, where the light sources in the direct-type backlight module are distributed at the bottom of a light guide plate, and such a backlight module is generally applicable to a display, a TV set, or another liquid crystal display device with a large size; and the light sources in the edge-lighting type backlight module are distributed on the sides of a light guide plate, and such a backlight module is generally applicable to a notebook PC, a tablet PC, a handset, or another display device with a small size.

As illustrated in FIG. 1, a general structure of the edge-lighting type backlight module in the liquid crystal display device includes a rear cover 31, and a reflector 32, a light guide plate 33, and an optical sheet 34 which are located and arranged in that order in an accommodating space of the rear cover 31, a LED BAR 35 located at the light incidence side of the light guide plate 33, and a mold frame 16 located above the optical sheet 34 and connected with the rear cover 31.

While the backlight module is operating, light emitted by a light source enters the light guide plate from one side end face thereof, and then totally reflected back and forth between upper and lower surfaces and two side faces of the light guide plate to thereby advance toward the other side end face of the light guide plate; and the reflected light reaching scattering netted dots on the lower bottom face of the light guide plate is scattered to the respective directions, and the total reflection condition is not satisfied, so that a part of the scattered light has a chance to be transmitted out of the light guide plate from the upper surface thereof, where this part of the scattered light is referred to as output light. The reflector is configured to reflect the light emitted from the back face to the front face to thereby enhance the intensity of the light; and the optical sheet is configured to diffuse and converge the output light to thereby guarantee brightness and uniformity required of the backlight module.

The inventors have identified during making of the inventors such a drawback of the backlight module in the prior art that there may be such significant assembling errors of the spacing between two adjacent LEDs in the LED BAR, and the spacing between the LED BAR, and the light incidence face of the light guide plate that may result in a poor picture displayed by the backlight module.

### SUMMARY

Embodiments of the disclosure provide a self-illuminating light guide plate, a backlight module, and a display device so as to improve the optical quality of the backlight module, and further the quality of a picture on the display device.

Some embodiments of the disclosure provide a self-illuminating light guide plate including a substrate including at least one light incidence face provided with a white light emitting layer.

The white light emitting layer includes a first electrode thin film, a white light quantum dot material thin film, and a second electrode thin film which are arranged in that order on the light incidence face.

The first electrode thin film is a cathode thin film, and the second electrode thin film is an anode thin film.

The cathode thin film is a metal oxide thin film, and the anode thin film is a metal thin film.

The metal oxide thin film is an indium tin oxide thin film.

The white light quantum dot material thin film includes a manganese cadmium sulfide (CDMnS) thin film, a cadmium selenium (CdSe) thin film, or a cadmium sulfide (CdS) thin film.

The light incidence face is an upper surface or a side end face of the substrate.

There is a protecting thin film which is a polyethylene terephthalate (PET) thin film between each light incidence face of the substrate, and the white light emitting layer.

In the technical solutions according to some embodiments of the disclosure, each light incidence face of the substrate is provided with a white light emitting layer, so the self-illuminating light guide plate applicable to a backlight module can act as a light source, and as compared with the prior art in which the LED BAR acts as light sources, some embodiments of the disclosure can avoid a picture of the backlight module from becoming poor due to an error in assembling the LED BAR, and further improve the quality of the picture on a display device; and moreover light emitted by the white light emitting layer can vary with the shape of the substrate, so a display device with a curved display surface to which the self-illuminating light guide plate is applied will have a promising prospective.

Some embodiments of the disclosure further provide a backlight module including the self-illuminating light guide plate according to any one of the technical solutions above. The backlight module to which the self-illuminating light guide plate according to any one of the technical solutions above is applied has a higher optical quality, and a better display effect.

Some embodiments of the disclosure further provide a display device including the backlight module according to any one of the technical solutions above. The display device including the backlight module with a higher optical quality has a better display effect; and moreover the light emitted by the white light emitting layer can vary with the shape of the substrate, so a display device with a curved display surface to which the backlight module is applied will have a promising prospective.

### BRIEF DESCRIPTION OF THE DRAWINGS

In order to make the technical solutions according to some embodiments of the disclosure or in the prior art more apparent, the drawings to which a description of the embodiments or the prior art refers will be briefly introduced below, and apparently the drawings to be described below are merely illustrative of some of embodiments of the disclosure, and those ordinarily skilled in the art can derive from these drawings other drawings without any inventive effort. In the drawings:

FIG. 1 is a schematic structural diagram of a cross section of the backlight module in the prior art;

FIG. 2 is a schematic structural diagram of a cross section of a backlight module according to some embodiments of the disclosure;

FIG. 3 is a schematic structural diagram of a cross section of a self-illuminating light guide plate according to some embodiments of the disclosure;

FIG. 4 is a schematic structural diagram of a cross section of a self-illuminating light guide plate according to some embodiments of the disclosure;

FIG. 5 is a schematic structural diagram of a cross section of a self-illuminating light guide plate according to some embodiments of the disclosure; and

FIG. 6 is a schematic structural diagram of a cross section of a self-illuminating light guide plate according to some embodiments of the disclosure.

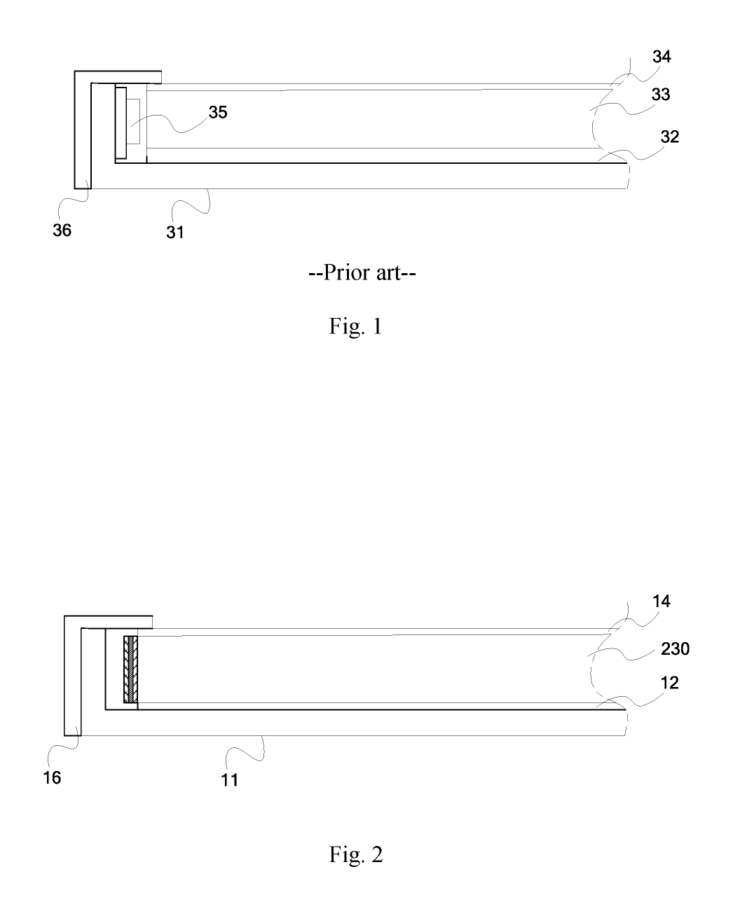

### REFERENCE NUMERALS

In the prior art:

31—Rear cover

32—Reflector

33—Light guide plate

34—Optical sheet

35—LED BAR

In embodiments of the disclosure:

11—Rear cover

12—Reflector

13—Light guide plate

14—Optical sheet

15—LED BAR

16—Mold frame

230—Self-illuminating light guide plate

300—Substrate

200—White light emitting layer

20—First electrode thin film

21—White light quantum dot material thin film

22—Second electrode thin film

23—Protecting thin film

### DETAILED DESCRIPTION OF THE EMBODIMENTS

In order to make the objects, technical solutions, and advantages of embodiments of the disclosure more apparent, the technical solutions according to embodiments of the disclosure will be described below clearly and fully with reference to the drawings in embodiments of the disclosure, and apparently embodiments described below are only a part but not all of embodiments of the disclosure. Based upon embodiments here of the disclosure, all the other embodiments which can occur to those skilled in the art without any inventive effort shall fall into the scope of the disclosure.

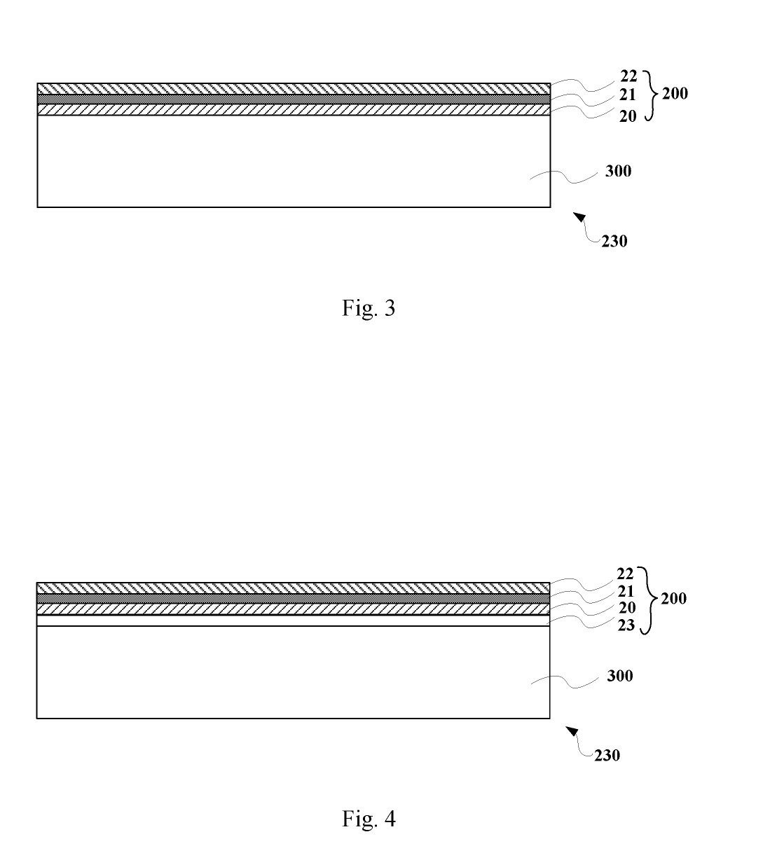

As illustrated in FIG. 3, some embodiments of the disclosure provide a self-illuminating light guide plate 230 including a substrate 300 including at least one light incidence face provided with a white light emitting layer 200.

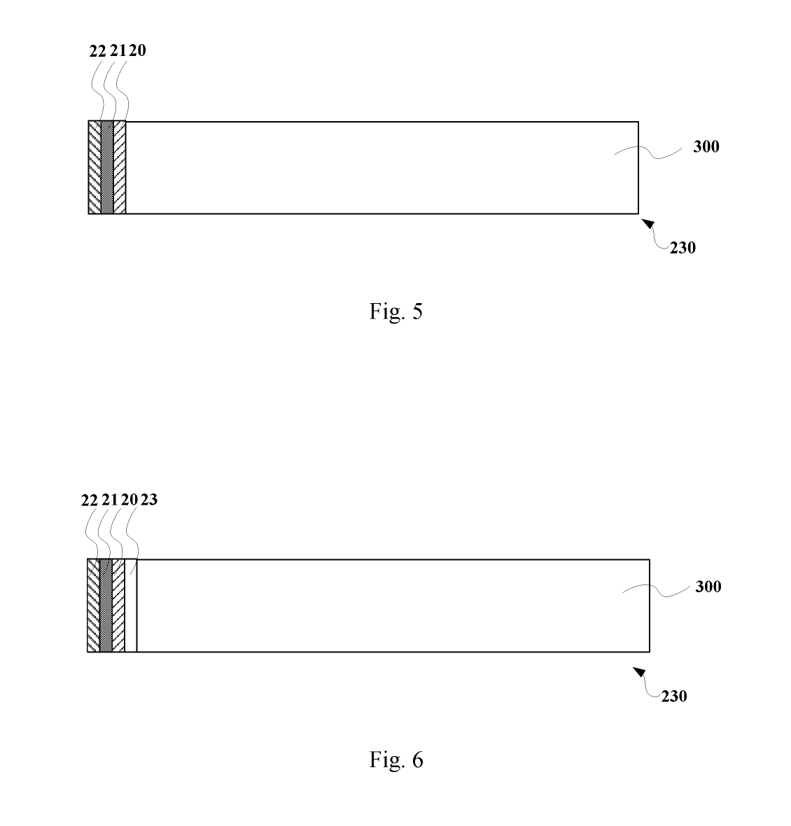

Here the light incidence face can be any plane of the substrate, and preferably the light incidence face is an upper surface or a side end face of the substrate, where the light incidence face is an upper surface of the substrate in the self-illuminating light guide plate as illustrated in FIG. 3 and FIG. 4, and a side end face of the substrate in the self-illuminating light guide plate as illustrated in FIG. 5 and FIG. 6.

In some embodiments of the disclosure, the light incidence face of the substrate is provided with a white light emitting layer, so the self-illuminating light guide plate applicable to a backlight module can act as a light source, and as compared with the prior art in which the LED BAR acts as light sources, some embodiments of the disclosure can avoid a picture of the backlight module from becoming poor due to an error in assembling the LED BAR, and further improve the quality of the picture on a display device; and moreover light emitted by the white light emitting layer can vary with the shape of the substrate, so a display device with a curved display surface to which the self-illuminating light guide plate is applied will have a promising prospective.

In a preferred embodiment of the disclosure, the white light emitting layer 20 includes a first electrode thin film 20, a white light quantum dot material thin film 21, and a second electrode thin film 22 which are arranged in that order on the light incidence face, where if the first electrode thin film is a cathode thin film, then the second electrode thin film will be an anode thin film; and alike if the first electrode thin film is an anode thin film, then the second electrode thin film will be a cathode thin film.

The cathode thin film will not be limited to any particular type, for example, the cathode thin film can be a metal oxide thin film, e.g., indium tin oxide, etc.; and the white light quantum dot material thin film 21 will not be limited to any particular type, for example, the white light quantum dot material thin film 21 can be a manganese cadmium sulfide (CDMnS) thin film, a cadmium selenium (CdSe) thin film, a cadmium sulfide (CdS) thin film, etc.; and the anode thin film will not be limited to any particular type, for example, the anode thin film can be a metal thin film, etc.

After the backlight module including the self-illuminating light guide plate is powered on, an electric field is formed between the anode thin film and the cathode thin film, and crystal lattices in the white light quantum dot material thin film are collapsed, thus resulting in an intermediate state of electron transition; and after electrons of the anode thin film are excited from their ground state, they undergo the intermediate state and then jump to the excited state, and further jump back to the ground state from the excited state. In this process, the white light quantum dot material thin film releases a series of visible light at different energies, all of which are superimposed onto each other, thus resulting in stable and uniform white light.

In another preferred embodiment of the disclosure, there is a protecting thin film 23 between each light incidence face of the substrate, and the white light emitting layer. This design facilitates formation of the cathode thin film on the protecting thin film and can protect the light guide plate. The protecting thin film will not be limited to any particular type, for example, the protecting thin film can be a polyethylene terephthalate (PET) thin film, etc.

As illustrated in FIG. 2, some embodiments of the disclosure provide a backlight module including the self-illuminating light guide plate 230 according to any one of the embodiments above.

Particularly the backlight module includes a rear cover 11 including an accommodating space, a reflector 12, the self-illuminating light guide plate 20, and an optical sheet 14 located and arranged in that order in the accommodating space of the rear cover 11, and a mold frame 16 located above the optical sheet 14 and connected with the rear cover 11. The backlight module to which the self-illuminating light guide plate according to any one of the technical solutions above is applied has a higher optical quality, and a better display effect.

Some embodiments of the disclosure further provide a display device including the backlight module according to any one of the technical solutions above. The display device including the backlight module with a higher optical quality has a better display effect; and moreover the light emitted by the white light emitting layer can vary with the shape of the substrate, so a display device with a curved display surface to which the backlight module is applied will have a promising prospective. The display device will not be limited to any particular type, for example, the display device can be a liquid crystal TV set, a liquid crystal display, a tablet computer, etc.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

1. A self-illuminating light guide plate, comprising a substrate comprising at least one light incidence face provided with a white light emitting layer.

2. The self-illuminating light guide plate according to claim 1, wherein the white light emitting layer comprises a first electrode thin film, a white light quantum dot material thin film, and a second electrode thin film arranged in that order on the light incidence face.

3. The self-illuminating light guide plate according to claim 2, wherein the first electrode thin film is a cathode thin film, and the second electrode thin film is an anode thin film.

4. The self-illuminating light guide plate according to claim 3, wherein the cathode thin film is a metal oxide thin film, and the anode thin film is a metal thin film.

5. The self-illuminating light guide plate according to claim 4, wherein the metal oxide thin film is an indium tin oxide thin film.

6. The self-illuminating light guide plate according to claim 2, wherein the white light quantum dot material thin film comprises a manganese cadmium sulfide (CDMnS) thin film, a cadmium selenium (CdSe) thin film, or a cadmium sulfide (CdS) thin film.

7. The self-illuminating light guide plate according to claim 1, wherein the light incidence face is an upper surface or a side end face of the substrate.

8. The self-illuminating light guide plate according to claim 1, wherein there is a protecting thin film which is a polyethylene terephthalate (PET) thin film between each light incidence face of the substrate, and the white light emitting layer.

9. A backlight module, comprising a self-illuminating light guide plate, wherein the self-illuminating light guide plate comprises a substrate comprising at least one light incidence face provided with a white light emitting layer.

10. The backlight module according to claim 9, wherein the white light emitting layer comprises a first electrode thin film, a white light quantum dot material thin film, and a second electrode thin film arranged in that order on the light incidence face.

11. The backlight module according to claim 10, wherein the first electrode thin film is a cathode thin film, and the second electrode thin film is an anode thin film.

12. The backlight module according to claim 11, wherein the cathode thin film is a metal oxide thin film, and the anode thin film is a metal thin film.

13. The backlight module according to claim 12, wherein the metal oxide thin film is an indium tin oxide thin film.

14. The backlight module according to claim 10, wherein the white light quantum dot material thin film comprises a manganese cadmium sulfide (CDMnS) thin film, a cadmium selenium (CdSe) thin film, or a cadmium sulfide (CdS) thin film.

15. The backlight module according to claim 9, wherein the light incidence face is an upper surface or a side end face of the substrate.

16. The backlight module according to claim 9, wherein there is a protecting thin film which is a polyethylene terephthalate (PET) thin film between each light incidence face of the substrate, and the white light emitting layer.

17. A display device, comprising a backlight module comprising a self-illuminating light guide plate, wherein the self-illuminating light guide plate comprises a substrate comprising at least one light incidence face provided with a white light emitting layer.

18. The display device according to claim 17, wherein the white light emitting layer comprises a first electrode thin film, a white light quantum dot material thin film, and a second electrode thin film arranged in that order on the light incidence face.

19. The display device according to claim 18, wherein the first electrode thin film is a cathode thin film, and the second electrode thin film is an anode thin film.

20. The display device according to claim 19, wherein the cathode thin film is a metal oxide thin film, and the anode thin film is a metal thin film.

21. The display device according to claim 20, wherein the metal oxide thin film is an indium tin oxide thin film.

22. The display device according to claim 18, wherein the white light quantum dot material thin film comprises a manganese cadmium sulfide (CDMnS) thin film, a cadmium selenium (CdSe) thin film, or a cadmium sulfide (CdS) thin film.

23. The display device according to claim 17, wherein the light incidence face is an upper surface or a side end face of the substrate.

24. The display device according to claim 17, wherein there is a protecting thin film which is a polyethylene terephthalate (PET) thin film between each light incidence face of the substrate, and the white light emitting layer.

11-24. (canceled)
